(19) United States
(12) Patent Application Publication
(10) Pub. No.: US 2017/0259815 A1
(43) Pub. Date: Sep. 14, 2017

(54) REAR ACCIDENT PROTECTION

(71) Applicant: TRW AUTOMOTIVE U.S. LLC, Farmington Hills, MI (US)

(72) Inventor: MARWAN REYADH SHAKER, Farmington Hills, MI (US)

(21) Appl. No.: 15/510,834

(22) PCT Filed: Oct. 13, 2015
(86) PCT No.: PCT/US15/55214

§ 371 Date: Mar. 13, 2017

Related U.S. Application Data
(60) Provisional application No. 62/064,135, filed on Oct. 15, 2014.

(51) Int. Cl. B60W 30/09; B60R 1/00; B60R 22/46; B60W 50/14; B60W 10/20; B62D 15/02; G08G 1/16; B60W 10/30; B60R 21/013; B60W 10/18

(52) U.S. Cl. CPC B60W 30/09; B60R 21/013; B60R 1/00; B60R 22/46; B60W 10/18; B60W 10/20; B62D 15/0265; G08G 1/166; B60W 10/30; B60W 50/14; B60R 2300/30; B60R 2300/8066; B60R 2022/4685; B60W 2710/18; B60W 2710/20; B60W 2710/30; B60W 2550/30

(57) ABSTRACT

A backward accident protection (BAP) system includes a video camera attached to the rear windshield of a vehicle. A microcomputer analyzes the camera image to assess the risk of a rear impacts. Upon detection of a potential rear impact, the BAP system initiates actions to reduce the severity of the potential rear impact.

### CROSS REFERENCE TO RELATED APPLICATIONS

This application claims priority to and the benefit of U.S. Provisional Application Ser. No. 62/064,135, filed 15 Oct. 2014, entitled REAR ACCIDENT PROTECTION. The above-identified provisional application is incorporated herein by reference in its entirety for all purposes.

### FIELD OF THE INVENTION

The present invention is directed to a system for the protection of a motor vehicle and its occupants against rear collision accidents.

### BACKGROUND

Audi AG introduced in 2010 on their A8 vehicle a system known as “Pre-Sense Rear.” This Audi system includes radar sensors whose field of view includes the area to the rear of the vehicle. If the radar senses the risk of a rear collision, the system automatically reacts by tightening the seat belts, closing the windows, and adjusting the rear seats. If a collision does not occur, the system restores these features to their previous settings.

### SUMMARY OF THE INVENTION

The present invention provides system for using a rearward facing camera for automatically taking steps to reduce the risk and consequences of rear collision accidents.

In accordance with one example embodiment of the present invention, a backward accident protection (BAP) system is provided for use in a ground-based motor vehicle. A camera is attached to the rear windshield of a vehicle. A microcomputer analyzes the camera image to detect potential rear impacts and provide signals related thereto. An interface is provided, responsive to the microcomputer signals for taking actions to reduce the severity of the potential rear impact.

In accordance with another example embodiment of the present invention, a backward accident protection system is provided for use in a ground-based motor vehicle having a rear windshield. The system includes a camera attached to the inside surface of the rear windshield for providing a camera image. A microcomputer analyzes the camera image to detect potential rear impacts and provide signals related thereto. An interface is provided that is responsive to the signals provided by the microcomputer and is adapted to be connected to at least one of a vehicle warning control subsystem, window control subsystem, safety systems subsystem, and vehicle dynamic controller subsystem for taking actions to reduce the severity of the potential rear impact. The microcomputer has stored therein at least two sets of risk criteria and analyzes the camera image to determine whether neither, one, or both of the at least two sets of criteria has been met. The microcomputer further performs phase one actions when a first of the sets of risk criteria is met, and performing phase two actions when a second of the sets of risk criteria is met.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a system in accordance with one example embodiment of the present invention, and

FIG. 2 is a diagrammatic representation of software operations performed by the microcomputer in the system of FIG. 1.

### DETAILED DESCRIPTION

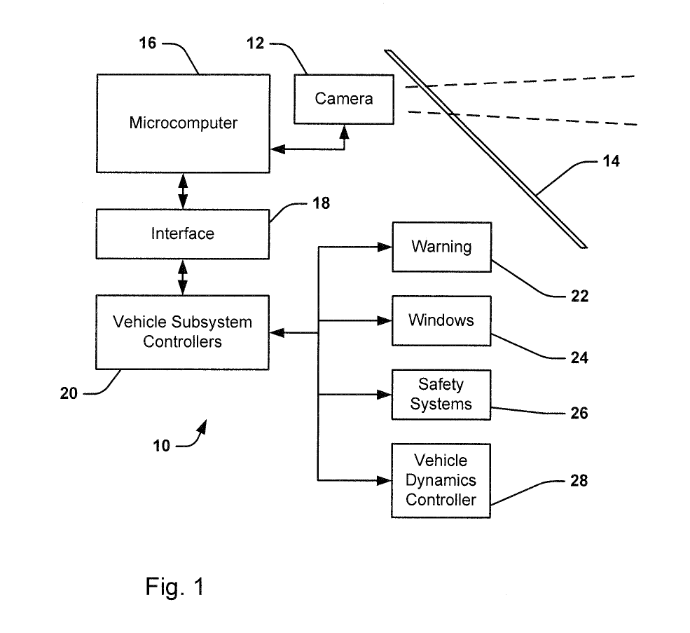

A system in accordance with the present invention, which provides backward accident protection (BAP), is shown in FIG. 1. The BAP system 10 includes a color camera 12, which is preferably a digital camera such as a CMOS imager, providing a digital output signal. The digital signal from camera 12 is supplied to and processed by a microcomputer 16. The camera 12 and microcomputer 16 are both contained within a single, common module housing. The module housing, not shown in the Figure, is attached to the inside surface of the rear windshield 14 of a vehicle in any conventional manner used for attaching electronic devices to windshields. The mounting structure includes a bracket permanently glued to the inside surface of the rear window. The module housing snaps into the bracket in a spatial orientation selected to precisely align the field of view of camera 12 relative to the rear of the vehicle. The module is mounted high on the rear window, in an area chosen to optimize the view afforded to camera 12 while also minimizing the degree to which the module obstructs the driver's view through the rear window.

In the preferred embodiment the camera and microcomputer are integrated into a single housing, as described above. Alternatively, however, the microcomputer may be located elsewhere in the vehicle, remote from the camera, and electrically attached to the camera with suitable wiring.

Microcomputer 16 has stored therein appropriate software, including image analysis software, for analyzing the digital video signal from the rear camera thereby to assess the risk of a rear impact. The analysis may be based in part or in whole upon the size and character of one or more rear objects (e.g., one or more large or small vehicles approaching from the rear) in the field of view of the camera, together with the present location, closing velocity and acceleration of those objects. Upon a detection of a potential rear impact, the BAP system will issue commands to initiate actions to avoid, or to reduce the severity of, the potential rear impact. The commands will be communicated to other vehicle subsystems via an interface 18, through which the microcomputer communicates with other vehicle subsystem controllers 20.

Such actions will include the provision of a warning to the driver via a suitable visual or audio warning 22, other active protective measures 24, 26 involving actuated vehicle systems such as seat belts and windows, and possibly the provision of a visual warning (e.g. flashing tail lights) to drivers of trailing vehicles. The BAP system may also, in suitably equipped vehicles, initiate vehicle action autonomously (that is, without driver input) via vehicle dynamics subsystems 28. These actions will be performed in two phases, or, optionally, in three phases, with the staging of the phases being based on level of risk. The level of risk may, for example, comprise an estimated time-to-rear-impact and/or other risk criteria based on the estimated distance, closing velocity and acceleration of the trailing vehicle. More sophisticated modeling of the motion of the trailing vehicle may also be conducted, based on the observed dynamics of the trailing vehicle in three dimensions along with, for example, an estimated mass of the trailing vehicle derived by matching the image of the trailing vehicle to a stored library of known vehicle types. The criteria may also be functionally dependent upon the velocity of the vehicle upon which the system is mounted.

Upon determining that there is a substantial risk of a rear impact (that is, the risk is above a certain threshold or the rear image contains threats that otherwise meet established risk criteria), the BAP will perform ‘phase 1’ steps. The BAP system will provide the driver with a warning 22 that a vehicle approaching from the rear is at imminent risk of colliding with the BAP-equipped vehicle. For the duration of this warning, the side windows of the vehicle will be partially or fully closed via block 24 to minimize damages caused by driver/passenger hitting them. The brake lights of the vehicle will be flashed in a regular or irregular pattern to catch the attention of the driver in the trailing vehicle. The warning will optionally include explicit visual and/or audio instructions to the driver to accelerate to minimize the risk of the rear impact since, although it may seem counter-intuitive, sometimes the best way to avoid an accident is to accelerate and get out of the way.

If the risk of impact is determined to be above a second, higher threshold or the vehicle rearward situation otherwise meets other established risk criteria, the BAP system will perform ‘phase 2’ steps. The vehicle seat-belts will be pre-tensioned via block 26 to cinch the driver and passengers back against their respective seats thereby to better position and secure them for possible airbag deployment and vehicle impact. Other vehicle cab components, such as active head rests and knee bolsters may be adjusted as well via block 26. Active components may be irreversible (e.g., pyrotechnically operated) or reversible (e.g. servomotor operated). To the extent that the phase 2 steps are reversible, they will be undone by returning the respective component to their prior positions if and when the risk of collision passes. As optional ‘phase 3’ steps the BAP system may instruct the vehicle dynamics subsystem 28 to maneuver the vehicle to avoid or minimize the anticipated rear impact. If forward-looking sensors (not shown) report that the road ahead is clear, the maneuver will preferably comprise acceleration of the vehicle in a straight line away from the vehicle approaching from the rear. In more sophisticated vehicles having steering servomotors and systems for safely controlling the servomotors, the vehicle dynamics subsystem 28 may also or instead be instructed by the BAP system (via subsystem controllers 20) to steer the vehicle into an open adjacent lane to avoid the anticipated rear impact. The optional ‘phase 3’ steps may be performed upon a match of risk criterion either before, during, or after the ‘phase 2’ steps but, as the criteria will be more stringent than the phase 1 criteria, will in any case be performed after the ‘first phase’ steps.

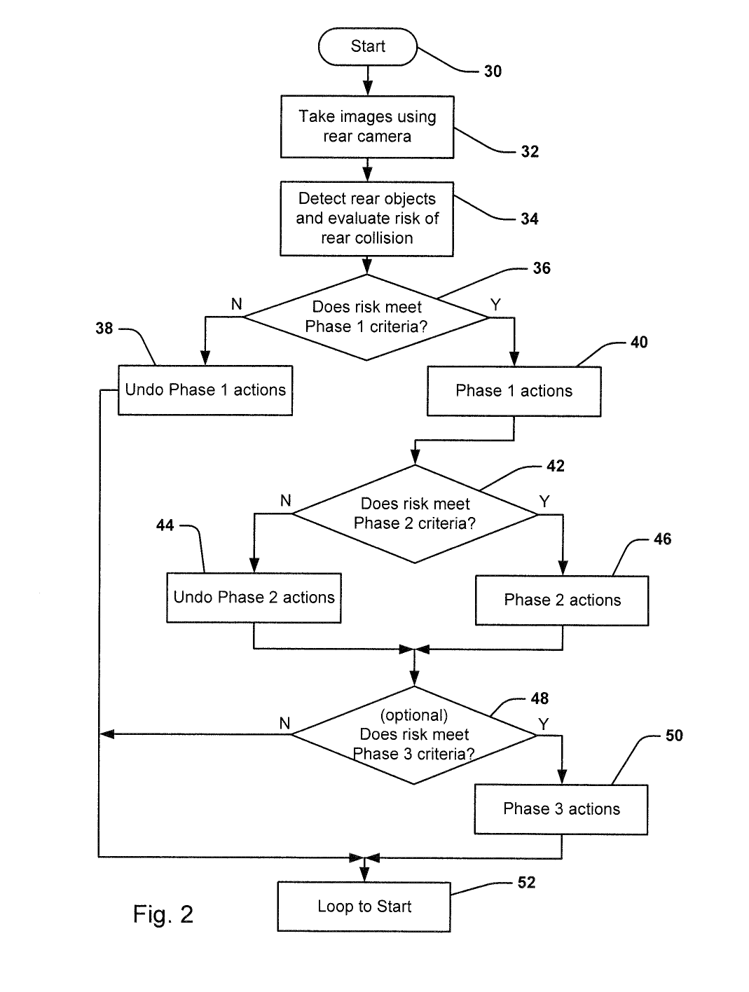

The various BAP system actions, managed by the microcomputer under programmatic control, are illustrated in the simplified flow chart of FIG. 2. FIG. 2 is a repetitive loop that will be performed by the microcomputer many times each second. The program loop starts at step 30 and the taking of new rear images at step 32. At step 34 the images are processed to detect rear objects and evaluate risk of a rear collision. The phase 1, phase 2, and phase 3 tests are performed in the diamond-shaped decision blocks 36, 42, and 48 in the flow chart of FIG. 2. The speed of the microcomputer is such that the tests will seem to occur virtually simultaneously. Normally, none of the three tests will be met and the system will progress repeatedly through the loop with no responsive vehicle action being taken. When a real rear threat arises and the phase 1 criteria are met at step 36, however, the phase 1 steps will be performed at step 40 and, as long as the phase 1 criteria continue to be met in subsequent passes through the loop, phase 2 and phase 3 tests 42, 48 will also each be performed. Phase 2 and phase 3 tests 42, 48 are independent of one another and thus, during a single incident involving a developing threat to the rear of the vehicle, phase 2 actions 46 may be triggered, phase 3 actions 50 may be triggered, neither of the phase actions 46, 50 may be triggered, or indeed both phase actions 46 and 50 may be triggered. Moreover, the phase 3 criteria may be met before, after, or at the same time as, the phase 2 criteria are met, resulting in phase 3 actions in some cases preceding phase 2 actions, in some cases succeeding phase 2 actions, or even in some cases occurring at essentially the same time.

From the above description of the invention, those skilled in the art will perceive improvements, changes and modifications. Such improvements, changes and modifications within the skill of the art are intended to be covered by the appended claims.

Having described the invention, the following is claimed:

1. A backward accident protection system for use in a ground-based motor vehicle, comprising a camera attached to the rear windshield of a vehicle, a microcomputer for analyzing the camera image to detect potential rear impacts and provide signals related thereto, and an interface responsive to said signals provided by said microcomputer for taking actions to reduce the severity of the potential rear impact.

2. A backward accident protection system as set forth in claim 1, wherein said interface is adapted to be connected to at least one of a vehicle warning control subsystem, window control subsystem, safety systems subsystem, and vehicle dynamic controller subsystem.

3. A backward accident protection system as set forth in claim 1, wherein said microcomputer has stored therein at least two sets of risk criteria, and further said microcomputer analyzes said camera image to determine whether neither, one, or both of said sets of criteria has been met.

4. A backward accident protection system as set forth in claim 3, wherein said microcomputer further performs phase one actions when a first of said sets of risk criteria is met, and performs phase two actions when a second of said sets of risk criteria is met.

5. A backward accident protection system as set forth in claim 4, wherein said microcomputer performs, among said phase one actions, driver warning and window roll-up actions.

6. A backward accident protection system as set forth in claim 4, wherein said microcomputer performs, among said phase two actions, seat belt pretensioning.

7. A backward accident protection system as set forth in claim 4, wherein said microcomputer further performs phase three actions when a third of said sets of risk criteria is met, said phase three actions including risk-avoiding vehicle maneuvers including at least one of steering and braking.

8. A backward accident protection system as set forth in claim 1, wherein said camera is adapted to be mounted on the inside surface of said rear windshield of a vehicle in a location to optimize the rear view afforded the camera while also minimizing the degree to which the module obstructs the driver's view through the rear window.

9. A backward accident protection system as set forth in claim 1, wherein said microcomputer analyzes the camera image to determine risk according to at least one criterion from the group including estimated time-to-rear-impact, and estimated distance, closing velocity and acceleration of the trailing vehicle.

10. A backward accident protection system for use in a ground-based motor vehicle having a rear windshield, comprising a camera attached to the inside surface of said rear windshield for providing a camera image, a microcomputer for analyzing said camera image to detect potential rear impacts and provide signals related thereto, and an interface responsive to said signals provided by said microcomputer and adapted to be connected to at least one of a vehicle warning control subsystem, window control subsystem, safety systems subsystem, and vehicle dynamic controller subsystem for taking actions to reduce the severity of the potential rear impact, wherein said microcomputer has stored therein at least two sets of risk criteria and analyzes said camera image to determine whether neither, one, or both of said at least two sets of criteria has been met, said microcomputer further performing phase one actions when a first of said sets of risk criteria is met, and performing phase two actions when a second of said sets of risk criteria is met.

11. A backward accident protection system as set forth in claim 10, wherein said microcomputer performs, among said phase one actions, driver warning and window roll-up actions.

12. A backward accident protection system as set forth in claim 10 wherein said microcomputer performs, among said phase two actions, seat belt pretensioning.

13. A backward accident protection system as set forth in claim 10, wherein said microcomputer further performs phase three actions when a third of said sets of risk criteria is met, said phase three actions including risk-avoiding vehicle maneuvers vehicle maneuvers including at least one of steering and braking.

14. A backward accident protection system as set forth in claim 10, wherein said microcomputer analyzes the camera image to determine risk according to at least one criterion from the group including estimated time-to-rear-impact, and estimated distance, closing velocity and acceleration of the trailing vehicle.
